(19) United States
(12) Patent Application Publication
(10) Pub. No.: US 2003/0094125 A1
(43) Pub. Date: May 22, 2003

(54) Lead edge feed wheel for use in the feed unit of an industrial sheet printing machine

(76) Inventor: Hung Ta Hsueh, Taipei (TW)

Correspondence Address: Hung Ta Hsueh, No. 34, Lane 87, Fu I Street, Chi Tu, Keelung 206, TW

(21) Appl. No.: 09/988,479

(22) Filed: Nov. 20, 2001

(51) Int. Cl. G01D 21/00

(52) U.S. Cl. 116/208

(57) ABSTRACT

A lead edge feed wheel mounted on a metal wheel rim for use in the feed unit of an industrial sheet printing machine, the lead edge feed wheel having a wheel body, and a face layer fixedly covered on the periphery of the wheel body, the face layer having a color different from the color of the wheel body, and a wall thickness equal to the maximum thickness of the lead edge feed wheel allowed to be worn away.

### BACKGROUND OF THE INVENTION

The present invention relates to a lead edge feed wheel for use in the feed unit of an industrial sheet printing machine and, more particularly, to such a lead edge feed wheel, which gives a visual color warning signal when worn to a predetermined extent, informing the operator to make a replacement.

FIG. 1 illustrates a conventional industrial sheet-printing machine 90. During the operation of the industrial sheet-printing machine 90, the feed unit of the industrial sheet-printing machine 90 feeds the sheet 92 into the machine through a precise movement of feed wheels 91 and wheel box grates working in conjunction with a properly sized vacuum hold-down. The transmission, which is a totally enclosed oil bath system, houses all gears and cams as well as the grate lifting mechanism and interrupter mechanism. The transmission controls the wheel speed in time with the grate up/down movement. The feed wheels 91 have a soft urethane outer cover, which has a high coefficient of friction with the sheet 92. During machine idle (interrupt period), the sheet 92 is not contacting the wheels 91 because the grate is in the up position. Once the feed cycle has begun, the grate, which supports the sheet 92 in the area around the wheels 91, is lowered. This allows the sheet 92 to come into contact with the wheels 91. When velocity at the beginning of the feed cycle is nearly zero, but increases quickly to 100% of machine tangent velocity and remains these for the entire feed stroke to feed the sheet 92 to the feed rolls 93 and 94. The feed rolls 93 and 94 feed the sheet 92 forward to the impression roll 95 and the print cylinder 96 for printing. Because the feed wheels 91 have a high coefficient of friction with the sheet 92, the soft outer covers of the feed wheels 91 wear quickly with use. Usually, the thickness of the feed wheels 91 allowed to be worn away is about 1 mm. When over 1 mm of the wall thickness of feed wheels 91 worn away, accurate registration of the sheet 92, the following two problems occur.

1. The outer diameter of the feed wheels 91 become smaller, resulting in relatively slower feed velocity and inaccurate registration of the sheet.

2. After long uses of the feed wheels 91 in feeding short sizes of sheets, the middle part of the feed wheels 91 worn away while the two opposite peripheral side areas maintained intact. When changed to feed big sizes of sheets, the sheet been fed into the machine tends to be deviated from the source, causing an inaccurate registration.

Because the operator cannot accurately visually check the wearing condition of the feed wheels, a special measuring tool must be used to measure the outer diameter of the feed wheels regularly. In case the outer diameter of either feed wheel becomes shorter than a predetermined range, the respective feed wheel must be replaced. It is inconvenient to measure the outer diameter of the feed wheels frequently. Alternatively, the operator may replace the feed wheels regularly without measuring their outer diameter. The aforesaid both methods are neither simple nor practical.

### SUMMARY OF THE INVENTION

The present invention has been accomplished to provide a feed wheel for use in the feed unit of an industrial sheet-printing machine.

It is the main object of the present invention to provide a feed wheel for use in the feed unit of an industrial sheet-printing machine, which gives a color indication signal, informing the operator to make a replacement in time.

According to the present invention, the feed wheel comprises a wheel body adapted for mounting on a metal wheel rim, and a face layer fixedly covered on the periphery of the wheel body. The wheel body and the face layer are made of same flexible material, for example, urethane. However, the wheel body and the face layer have different colors. The wall thickness of the face layer is equal to the maximum thickness of the feed wheel allowed to be worn away. When the color of the wheel body is seen, it means that it's the time to replace the feed wheel.

### BRIEF DESCRIPTION OF THE DRAWINGS

FIG. 1 is a plain view of a conventional industrial sheet-printing machine.

FIG. 2 is an elevational view of a lead edge feed wheel constructed according to a first embodiment of the present invention.

FIG. 3 is a sectional view in axial direction of the lead edge feed wheel shown in FIG. 2.

FIG. 4 is a sectional view showing the lead edge feed wheel of FIG. 2 mounted on the corresponding metal wheel rim.

FIG. 5 is an elevational view of a lead edge feed wheel according to an alternate form of the present invention.

FIG. 6 is a sectional view showing the lead edge feed wheel of FIG. 5 mounted on the corresponding metal wheel rim.

FIG. 7 is an elevational view of a lead edge feed wheel according to another alternate form of the present invention.

FIG. 8 is a sectional view showing the lead edge feed wheel of FIG. 7 mounted on the corresponding wheel rim.

FIG. 9 an elevational view of a lead edge feed wheel according to still another alternate form of the present invention.

FIG. 10 is a sectional view showing the lead edge feed wheel shown of FIG. 9 mounted on the corresponding wheel rim.

FIG. 11 is a sectional view taken along line A-A of FIG. 10.

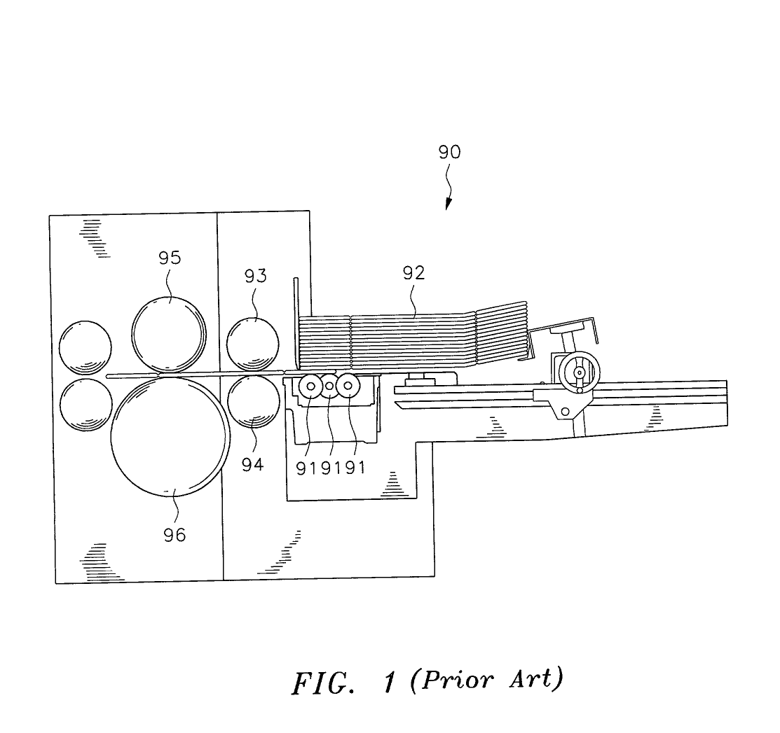

### DETAILED DESCRIPTION OF THE PREFERRED EMBODIMENT

Referring to FIGS. from 2 through 4, a lead edge feed wheel 10 is shown comprised of an annular wheel body 12 molded from elastic material of high coefficient of friction, for example, urethane, defining a mounting hole 14 adapted for mounting on a metal wheel rim 20. The annular wheel body 12 has a protruded flange 16 extended around the inside wall thereof and engaged into the peripheral coupling groove 22 of the metal wheel rim 20 (see FIG. 4). The metal wheel rim 20 is of the known art and not within the scope of the present invention, and therefore no further description of the metal wheel rim 20 is necessary. The lead edge feed wheel 10 further comprises a soft face layer 18 covered on the periphery of the wheel body 12. The face layer 18 and the wheel body 12 are made of same material. However, the face layer 18 and the wheel body 12 have different colors. For example, the wheel body 12 has the color of orange, and the face layer 18 has the color of green. Because the face layer 18 and the wheel body 12 have different colors, the color of the wheel body 12 is exposed to the outside when the face layer 18 worn away. The exposure of the color of the wheel body 12 gives a visual warning signal to the operator, informing the operator to replace the lead edge feed wheel 10 in time.

The thickness of the face layer 18 is the maximum thickness of the lead edge feed wheel 10 allowed to be worn away, which is set at about 1 mm. When the face layer 18 worn away, the lead edge feed wheel 10 must be replaced. If the lead edge feed wheel 10 is continuously used after wearing of the face layer 18, the sheet feeding speed will become excessively slow, resulting in an inaccurate registration.

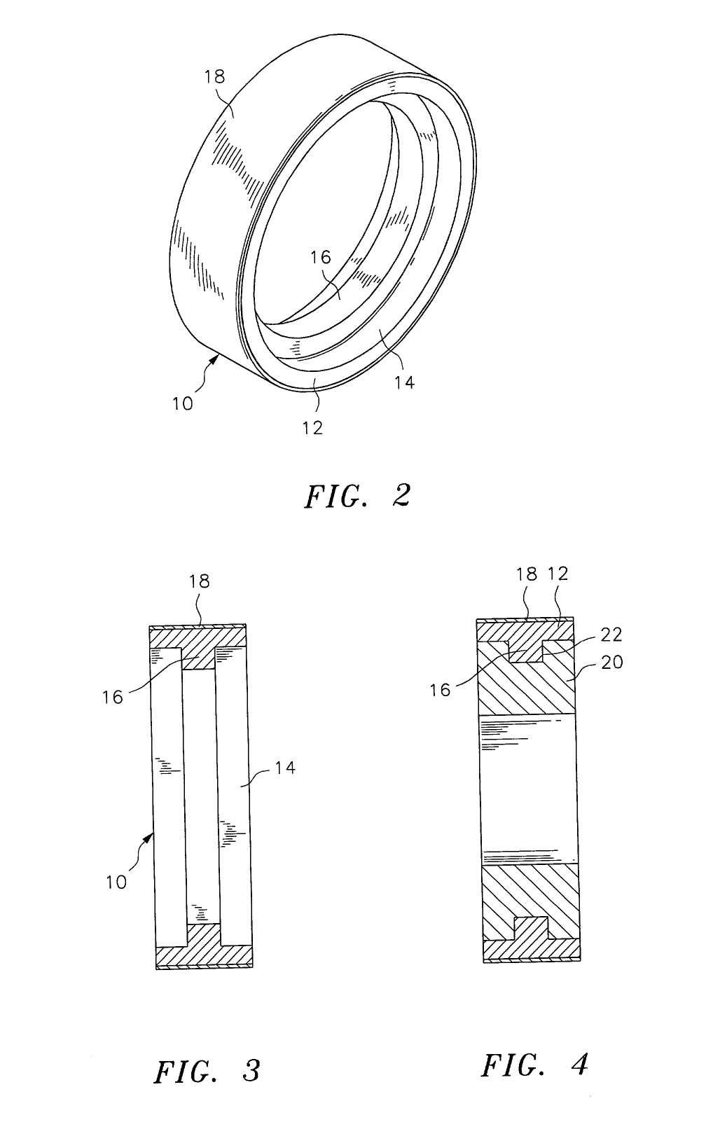

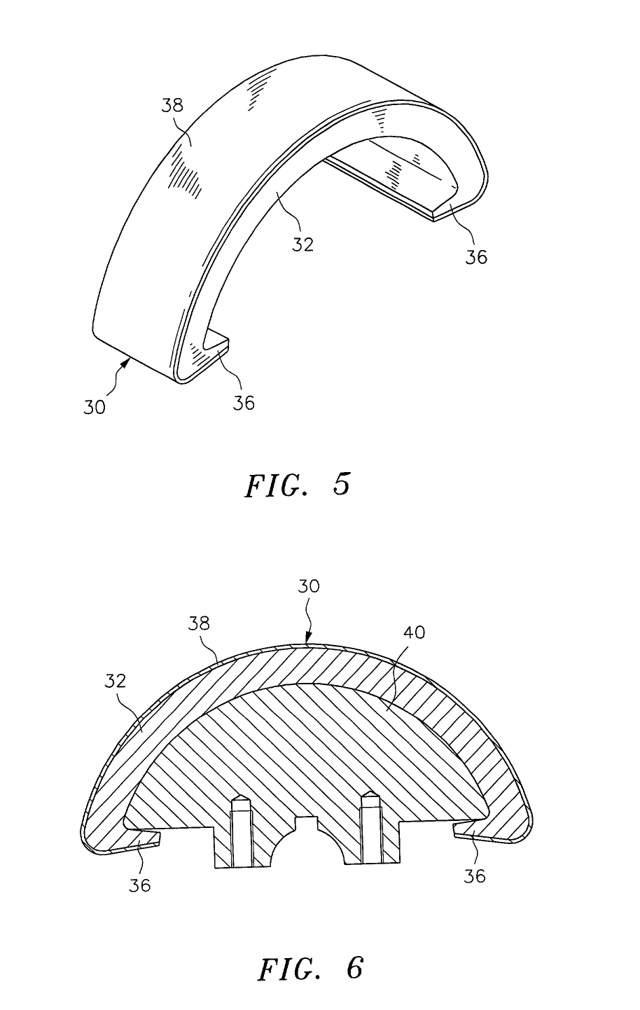

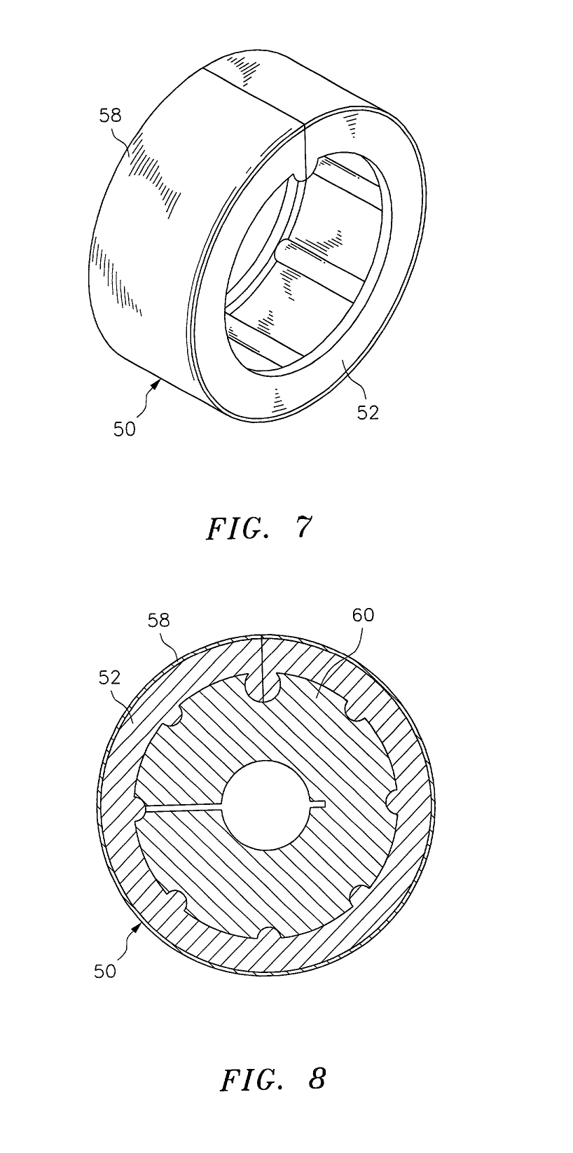

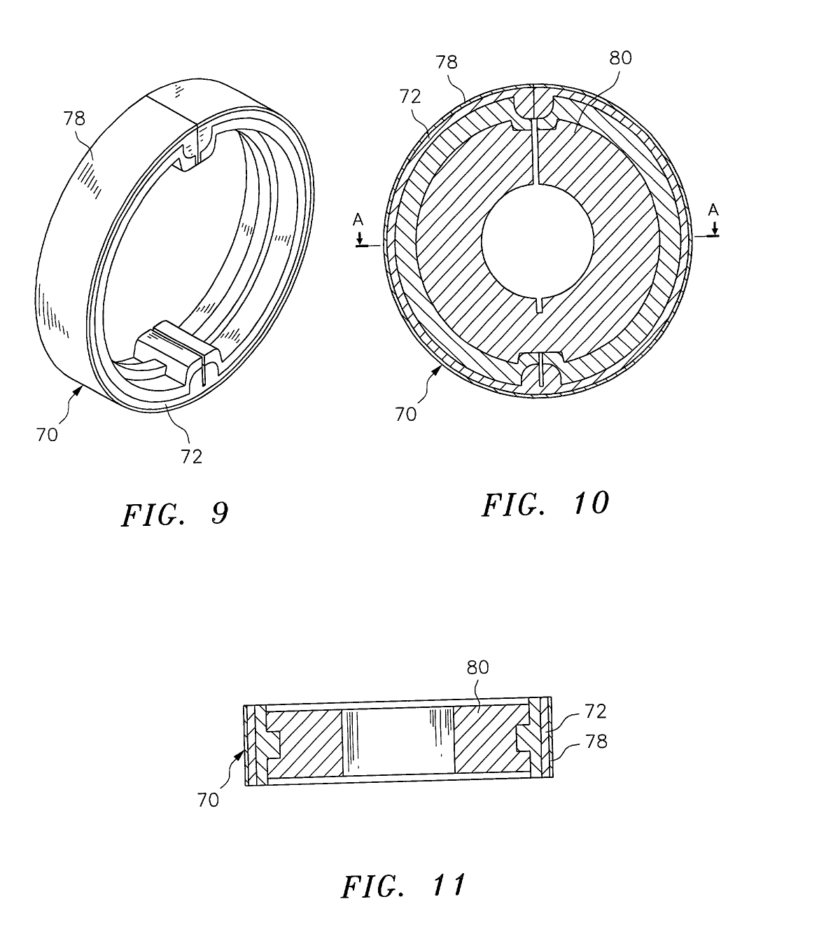

The structure of the lead edge feed varies with the feed unit of the industrial sheet printing system used. For example, the feed wheel 10 shown in FIGS. 2 and 3 is designed for use in Sun Extend-O-Feed System. FIG. 4 shows the feed wheel 10 mounted on the metal wheel rim 20. The feed wheel 30 shown in FIG. 5 is designed for use in Langston/Staley Rotofeed System. FIG. 6 shows the feed wheel 30 of FIG. 5 mounted on the corresponding wheel rim 40. The feed wheel 50 shown in FIG. 7 is designed for use in Prime Shur-Feed System. FIG. 8 shows the feed wheel 50 of FIG. 7 mounted on the corresponding wheel rim 60. The feed wheel 70 shown in FIG. 9 is designed for use in Snap-On System. FIGS. 10 and 11 show the feed wheel 70 of FIG. 9 mounted on the corresponding wheel rim 80.

In either of the aforesaid embodiments, the feed wheel 10, 30, 50, or 70 has an annular wheel body 12, 32, 52, or 72, and a face layer 18, 38, 58, or 78 covered on the periphery of the annular wheel body 12, 32, 52, or 72. The wheel body 12, 32, 52, or 72, and a face layer 18, 38, 58, or 78 have different colors so that the color of the wheel body 12, 32, 52, or 72 is seen when the face layer 18, 38, 58, or 78 worn away, and the color exposure of the wheel body 12, 32, 52, or 72 gives a visual warning signal to the operator, informing the operator to replace the feed wheel 10, 30, 50, or 70.

In the aforesaid embodiments, except the embodiment shown in FIGS. 5 and 6, the wheel body of the lead edge feed wheel has a protruded flange adapted for engaging into the peripheral coupling groove of the corresponding metal wheel rim. The lead edge feed wheel 30 shown in FIGS. 5 and 6 is a smoothly arched member having two retaining elements 36 respectively inwardly extended from the two distal ends thereof and respectively fastened to the bottom sidewall of the semicircular wheel rim 40 (see FIG. 6).

A prototype of lead edge feed wheel has been constructed with the features of FIGS. 2˜11. The lead edge feed wheel functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A lead edge feed wheel comprising an annular wheel body, said wheel body defining a center mounting hole adapted for mounting on a metal wheel rim, and a protruded flange extended around an inside wall thereof and adapted for engaging a peripheral coupling groove of the metal wheel rim on which said wheel body is mounted, wherein the lead edge feed wheel further comprises a face layer fixedly covered on the periphery of said wheel body, said face layer having a color different from the color of said wheel body, and a wall thickness equal to the maximum thickness of the lead edge feed wheel allowed to be worn away.

2. A lead edge feed wheel comprising a smoothly arched wheel body adapted for mounting on a semicircular metal wheel rim, and two retaining elements respectively inwardly extended from two distal ends thereof and adapted for fastening to the bottom sidewall of the semicircular wheel rim on which said wheel body is mounted, wherein the lead edge feed wheel further comprises a face layer fixedly covered on the periphery of said wheel body, said face layer having a color different from the color of said wheel body, and a wall thickness equal to the maximum thickness of the lead edge feed wheel allowed to be worn away.
